(19) United States
(12) Patent Application Publication
(10) Pub. No.: US 2026/0203192 A1
(43) Pub. Date: Jul. 16, 2026

(54) ANOMALY DETECTION BASED SELF-HEALTH CHECK SYSTEM FOR MONITORING PRODUCTS

(71) Applicant: International Business Machines Corporation, Armonk, NY (US)

(72) Inventors: Zhen Yi Jia, Beijing (CN); Bo Chen Zhu, Xi'an (CN); Ai Ping Feng, Beijing (CN); Qian Xia Song, Beijing (CN)

(21) Appl. No.: 19/017,964

(22) Filed: Jan. 13, 2025

(51) Int. Cl. G06F 11/362; G06F 11/07; G06F 11/3604

(52) U.S. Cl. CPC G06F 11/3636; G06F 11/0793; G06F 11/3612

(57) ABSTRACT

Examples described herein provide systems and methods for performing self-health checks in monitoring products. Aspects include scanning software code of a monitored product to identify and categorize different logical units, dividing the code into manage units and process units. The method generates a behavior profile for the monitored product by analyzing historical statistic data and historical behavior data, including distribution scopes and expected packet sizes for each unit. During operation, the method collects runtime statistic data and runtime behavior data, comparing them with the behavior profile to detect deviations from expected behavior. Upon detecting an anomaly, the method collects debug information by opening related traces and automatically performs corrective actions such as restarting the monitored product, reallocating resources, and optimizing the software code. The system reports detected anomalies to a user and updates the behavior profile based on user responses, ensuring continuous improvement and accurate anomaly detection.

### BACKGROUND

The disclosure relates to computer systems, specifically to methods and systems for performing self-health checks in application performance monitoring (APM) solutions through anomaly detection in program behavior and data characteristics.

In current architectures, the stability of the monitoring solution itself serves as an indicator for reliably performing the monitoring duties. Capturing information during incidents presents a formidable challenge, often resulting in late alerts based on traditional performance metrics. Additionally, there exists a possibility of performance metric data loss when problems occur. The information that needs to be collected is closely tied to program behavior, which includes identifying potential problems such as abnormal behavior and conducting health checks that encompass detailed workload statistics and diagnostic logs.

Existing monitoring solutions exhibit weaknesses as they are primarily designed to concentrate on performance metrics. This focus limits their ability to effectively capture and analyze anomalies, which are used for early detection and dynamic debugging. The need for a more comprehensive approach to self-health checks in monitoring products is evident, highlighting the need for a system that can dynamically collect and analyze relevant information to provide timely alerts and facilitate efficient problem resolution.

### SUMMARY

According to one aspect of the present invention, a computer-implemented method for performing self-health checks in monitoring products involves scanning software code of a monitored product to identify and categorize different logical units. The method includes dividing the code into manage units and process units. It also involves generating a behavior profile for the monitored product by analyzing historical statistic data and historical behavior data. The behavior profile includes distribution scopes for each process unit and manage unit and expected packet sizes for each process unit and manage unit. The method further includes collecting runtime statistic data and runtime behavior data during an operation of the monitored product. It compares the collected runtime data with the behavior profile to detect any deviations from expected behavior. Additionally, the method involves collecting debug information by opening related traces when an anomaly is detected in the behavior of the monitored product. Finally, it includes automatically performing a corrective action in response to the anomaly.

According to another aspect, a system includes a memory with computer-readable instructions and a processing device for executing the computer-readable instructions. The computer-readable instructions control the processing device to perform operations such as scanning software code of a monitored product to identify and categorize different logical units. The system divides the code into manage units and process units. It generates a behavior profile for the monitored product by analyzing historical statistic data and historical behavior data. The behavior profile includes distribution scopes for each process unit and manage unit and expected packet sizes for each process unit and manage unit. The system collects runtime statistic data and runtime behavior data during an operation of the monitored product. It compares the collected runtime data with the behavior profile to detect any deviations from expected behavior. Additionally, the system collects debug information by opening related traces when an anomaly is detected in the behavior of the monitored product. Finally, it automatically performs a corrective action in response to the anomaly.

According to yet another aspect, a computer program product for performing self-health checks in monitoring products includes a set of one or more computer-readable storage media. The program instructions are collectively stored in the set of one or more storage media. These instructions cause a processor set to perform the following computer operations: scanning software code of a monitored product to identify and categorize different logical units. The program divides the code into manage units and process units. It generates a behavior profile for the monitored product by analyzing historical statistic data and historical behavior data. The behavior profile includes distribution scopes for each process unit and manage unit and expected packet sizes for each process unit and manage unit. The program collects runtime statistic data and runtime behavior data during an operation of the monitored product. It compares the collected runtime data with the behavior profile to detect any deviations from expected behavior. Additionally, the program collects debug information by opening related traces when an anomaly is detected in the behavior of the monitored product. Finally, it automatically performs a corrective action in response to the anomaly.

The above features and advantages, and other features and advantages, of the disclosure, are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a block diagram illustrating a computing environment, according to one or more embodiments;

FIG. 2 is a block diagram illustrating a system for anomaly detection-based self-health checks in monitoring products, according to one or more embodiments;

FIG. 3 is a block diagram illustrating the system architecture for anomaly detection-based self-health checks in monitoring products, according to one or more embodiments;

FIGS. 4A and 4B are flow charts illustrating a method for performing a self-health check process for monitoring products based on anomaly detection, according to one or more embodiments; and

FIG. 5 is a flow chart illustrating for performing self-health checks in APM solutions through anomaly detection.

The detailed description explains embodiments of the disclosure, together with advantages and features, by way of example with reference to the drawings.

### DETAILED DESCRIPTION

According to one aspect of the present invention, a computer-implemented method for performing self-health checks in monitoring products includes scanning software code of a monitored product to identify and categorize different logical units, dividing the code into manage units and process units; generating a behavior profile for the monitored product by analyzing historical statistic data and historical behavior data. The behavior profile including distribution scopes for each process unit and manage unit and expected packet sizes for each process unit and manage unit. The method also includes collecting runtime statistic data and runtime behavior data during an operation of the monitored product, comparing the collected runtime data with the behavior profile to detect any deviations from expected behavior, and collecting debug information by opening related traces when an anomaly is detected in the behavior of the monitored product. The method further includes automatically performing a corrective action in response to the anomaly.

The method for performing self-health checks in monitoring products introduces a systematic approach to identifying and categorizing different logical units within the software code of a monitored product. By dividing the code into manage units and process units, the method ensures a granular level of analysis, which provides for accurate anomaly detection. This categorization allows for the generation of a detailed behavior profile that includes distribution scopes and expected packet sizes for each unit, providing a comprehensive reference for expected behavior. During the operation of the monitored product, the method collects runtime statistic data and runtime behavior data, which are then compared with the behavior profile to detect any deviations from expected behavior. This real-time comparison enables the early detection of anomalies, allowing for timely intervention before issues escalate. When an anomaly is detected, the method dynamically collects debug information by opening related traces, facilitating targeted debugging and efficient problem resolution. The automatic performance of corrective actions in response to detected anomalies ensures that the system can promptly address issues, thereby maintaining the stability and reliability of the monitored product. Examples of corrective actions include restarting the monitored product, reallocating resources, and optimizing the software code, all of which contribute to improved system performance and reduced downtime. This method enhances the overall effectiveness of self-health checks in monitoring products by providing a robust framework for anomaly detection and dynamic debugging, ultimately leading to a more stable and reliable monitoring solution.

According to another aspect, the computer-implemented method also includes reporting detected anomalies to a user and updating the behavior profile based on user responses to the reported detected anomalies. Classifying the feature groups of monitor behavior in a monitoring product and building the behavior profile for a specific system allows for a more granular and detailed analysis of the system's performance and behavior. By categorizing the monitor behavior into distinct feature groups, the method ensures that each aspect of the system's operation is thoroughly examined and understood. This classification facilitates the creation of a comprehensive behavior profile that includes specific characteristics and expected behaviors for each feature group. The behavior profile serves as a reference for detecting anomalies by providing baseline data against which runtime behavior can be compared. This structured approach enables the system to identify deviations from expected behavior more accurately and promptly. For example, if a particular feature group exhibits behavior outside its defined parameters, the system can quickly detect this anomaly and initiate appropriate debugging and corrective actions. This method enhances the system's ability to perform self-health checks by ensuring that all relevant aspects of the monitor behavior are considered and analyzed. It improves the accuracy of anomaly detection, reduces the time required for problem resolution, and ultimately contributes to the stability and reliability of the monitoring product. The detailed behavior profile also allows for continuous improvement, as it can be updated based on user feedback and new data, ensuring that the system remains effective in identifying and addressing potential issues.

According to yet another aspect, the historical statistic data includes metadata about data streams, such as data stream ID, packet ID, and packet size. Analyzing runtime monitor behavior for self-health checks allows for real-time detection of anomalies by continuously comparing the current operational data against a predefined behavior profile. This method ensures that any deviations from expected behavior are promptly identified, enabling early intervention before issues escalate. By focusing on runtime data, the system can dynamically capture and analyze relevant information, facilitating timely alerts and efficient problem resolution. This approach enhances the stability and reliability of the monitoring product by providing a proactive mechanism to detect and address potential problems as they occur, rather than relying solely on historical data or periodic checks. This real-time analysis provides for maintaining optimal performance and minimizing downtime in application performance monitoring (APM) solutions.

According to yet another aspect, the historical behavior data includes metadata about process units, such as data stream ID, process unit, and a number of times the process unit has been called. Dynamically capturing debug information based on unusual behavior allows for real-time identification and analysis of anomalies in the monitored product. This approach ensures that relevant debug information is collected at the earliest stage of anomaly detection, facilitating timely and targeted debugging efforts. By opening related traces dynamically, the system can gather detailed information about the specific conditions and context in which the anomaly occurred, which is used to provide accurate diagnosis and resolution of issues. This method reduces the time and effort required for manual debugging, enhances the accuracy of problem identification, and improves the overall efficiency of the self-health check process. Additionally, it minimizes the risk of missing critical information that could be lost if the debug information were not captured dynamically, thereby maintaining the stability and reliability of the monitoring product.

According to yet another aspect, the runtime statistic data includes metadata about data streams and process units. Including metadata about data streams and process units in the runtime statistic data allows for a more detailed and accurate analysis of the monitored product's behavior during its operation. By capturing metadata such as data stream IDs, packet IDs, and packet sizes, the system can track the flow and processing of data in real-time. This detailed tracking enables the system to detect deviations from expected behavior more precisely, as it can compare the current operational data against the predefined behavior profile. For example, if a data stream exhibits an unexpected increase in packet size or a process unit is called more frequently than usual, these anomalies can be promptly identified and addressed. This real-time monitoring and analysis enhance the system's ability to perform self-health checks, ensuring that potential issues are detected and resolved before they escalate, thereby maintaining the stability and reliability of the monitoring product.

According to yet another aspect, the runtime behavior data includes metadata about process units and their behavior. Including metadata about process units and their behavior in the runtime behavior data allows for a more detailed and accurate analysis of the monitored product's behavior during its operation. By capturing metadata such as data stream IDs, process unit IDs, and the number of times each process unit has been called, the system can track the behavior of individual process units in real-time. This detailed tracking enables the system to detect deviations from expected behavior more precisely, as it can compare the current operational data against the predefined behavior profile. For example, if a process unit exhibits an unexpected increase in the number of times it is called or behaves differently than usual, these anomalies can be promptly identified and addressed. This real-time monitoring and analysis enhance the system's ability to perform self-health checks, ensuring that potential issues are detected and resolved before they escalate, thereby maintaining the stability and reliability of the monitoring product.

According to yet another aspect, the corrective action includes one or more of restarting the monitored product, reallocating resources utilized by the monitored product, and optimizing the software code. Including corrective actions such as restarting the monitored product, reallocating resources utilized by the monitored product, and optimizing the software code ensures that the system can promptly address detected anomalies, thereby maintaining the stability and reliability of the monitored product. Restarting the monitored product can prevent crashes and ensure continuous availability, while reallocating resources can enhance the system's ability to handle peak loads and improve overall performance. Optimizing the software code can lead to more efficient use of system resources, reducing CPU and memory usage, and improving response times. These corrective actions directly address the root causes of anomalies, preventing minor issues from escalating into major failures, and ensuring that the monitoring product operates smoothly and efficiently. This approach minimizes downtime, reduces the risk of data loss, and enhances the overall effectiveness of the self-health check process.

In current application performance monitoring (APM) architectures, the stability of the monitoring solution itself serves as an indicator for reliably performing monitoring duties. Capturing information during incidents presents a formidable challenge, often resulting in late alerts based on traditional performance metrics. Additionally, there exists a possibility of performance metric data loss when problems occur. The information that needs to be collected is closely tied to program behavior, which includes identifying potential problems such as abnormal behavior and conducting health checks that encompass detailed workload statistics and diagnostic logs.

Existing monitoring solutions exhibit weaknesses as they are primarily designed to concentrate on performance metrics. This focus limits their ability to effectively capture and analyze anomalies, which are important for early detection and dynamic debugging. The need for a more comprehensive approach to self-health checks in monitoring products is evident, highlighting the need for a system that can dynamically collect and analyze relevant information to provide timely alerts and facilitate efficient problem resolution.

The present disclosure introduces a method and system for performing self-health checks in monitoring products through anomaly detection in program behavior and data characteristics. The method involves scanning the software code of a monitored product to identify and categorize different logical units, dividing the code into manage units and process units. A behavior profile is generated by analyzing historical statistic data and historical behavior data, including distribution scopes for each process unit and manage unit, as well as expected packet sizes. During the operation of the monitored product, runtime statistic data and runtime behavior data are collected and compared with the behavior profile to detect any deviations from expected behavior. When an anomaly is detected, related traces are dynamically opened to collect debug information, and corrective actions are automatically performed in response to the anomaly. This approach ensures comprehensive monitoring and analysis of program behavior and data characteristics, providing timely alerts and facilitating efficient problem resolution.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

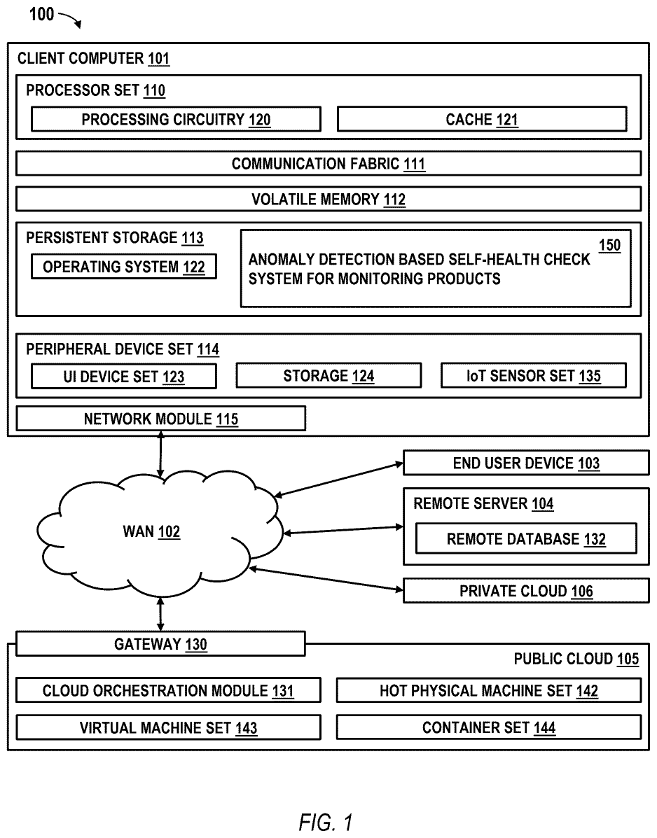

FIG. 1 illustrates a computing environment 100, according to an embodiment. Computing environment 100 contains an example of an environment for the execution of at least some of the computer code includes providing anomaly detection based self-health check system for monitoring products, as shown at block 150. In addition to a controller for controlling the operations of a metal cutting tool, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122, as identified above), peripheral device set 114 (including user interface (UI) device set 123, storage 124, and Internet of Things (IoT) sensor set 135), and network module 115. Remote server 104 includes remote database 132. Public cloud 105 includes gateway 130, cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in persistent storage 113 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 131. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the owner of the entity is also updated).

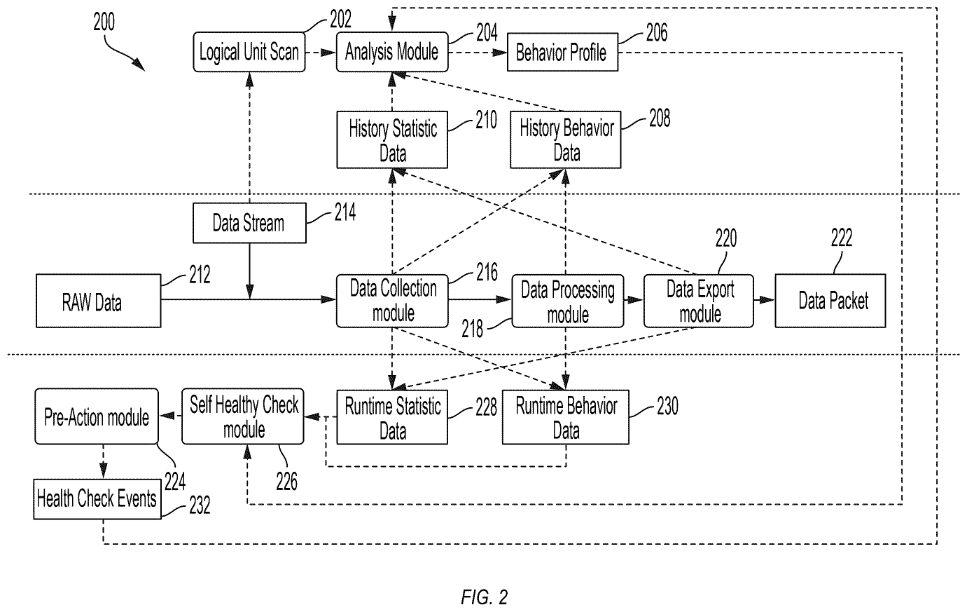

Referring now to FIG. 2, a block diagram of a system 200 for performing anomaly detection-based self-health checks in monitoring products is shown. In exemplary embodiments, the system 200 serves as the framework for the anomaly detection-based self-health check in monitoring products, integrating various modules and data flows to ensure comprehensive monitoring and analysis of program behavior and data characteristics. The logical unit scan 202 scans the software code of an application that is being monitored, referred to herein as the monitored product, to identify and categorize different logical units, dividing the code of the monitored product into manage units and process units. These units are responsible for controlling the process logics and processing data streams, respectively. The analysis module 204 processes the data collected from the logical unit scan 202, building a comprehensive behavior profile of the current system by analyzing history statistic data and history behavior data. This module formats the input data by data stream ID and performs code behavior analysis and monitor data analysis, calculating distribution scopes for each process unit and manage unit to detect anomalies during runtime.

In exemplary embodiments, the behavior profile 206, generated by the analysis module 204, contains detailed information about the expected behavior of the monitor product, including distribution scopes for each process unit and manage unit, as well as expected packet sizes. This profile is used as a reference during the self-health check process to detect any deviations from expected behavior. The history statistic data 210, collected during the typical monitor process, includes metadata about the data streams, such as data stream ID), packet ID, and packet size. This data provides a historical record of the data processed by the monitor product, which is used to build the behavior profile and detect anomalies. Similarly, the history behavior data 208 includes metadata about the process units, such as data stream ID, process unit, and the number of times the process unit has been called, providing a historical record of the monitor product's behavior. In one embodiment, the history behavior data 208 has a format of (SID, p, t) where SID is the data stream ID, used to specify the data stream, p is a process unit for the data stream, and t is the times that the p has been called.

In exemplary embodiments, the data stream 214 represents the flow of data through the monitor product, including raw data collected from various sources, which is then processed and analyzed by the system. The raw data 212 consists of unprocessed data collected from various sources, serving as the initial input for the monitoring system. The data collection module 216 gathers it operational data from diverse data sources, ensuring that all relevant data is collected and fed into the data stream 214 for further processing. The data processing module 218 converts and formats the collected data based on destination requirements, preparing the raw data for analysis by the analysis module 204. The data export module 220 sends the processed data to one or more destinations, ensuring that the data is available for further analysis and reporting.

In exemplary embodiments, the data packet 222 represents a unit of data that is processed and analyzed by the monitoring system, including metadata such as data stream ID, packet ID, and packet size, used to track and analyze the flow of data through the monitor product. The pre-action module 224 dynamically collects debug information if an anomaly is detected in the behavior of the monitor product, opening related traces and collecting useful information in the early stages of anomaly detection. The self-health check module 226 analyzes the runtime statistic data and runtime behavior data to detect abnormal behavior, comparing the current running status with the behavior profile and identifying any deviations from expected behavior.

In exemplary embodiments, the runtime statistic data 228, collected by the self-health check module 226 during the runtime of the monitor product, includes metadata about the data streams and process units, used to detect anomalies and update the behavior profile. The runtime behavior data 230, also collected by the self-health check module 226 during the runtime of the monitor product, includes metadata about the process units and their behavior, providing real-time information about the monitor product's behavior. The health check events 232 are generated by the self-health check module 226 when an anomaly is detected, including warnings and alerts that notify the user of potential problems with the monitor product, ensuring that the user is informed of any issues and can take appropriate action to resolve them.

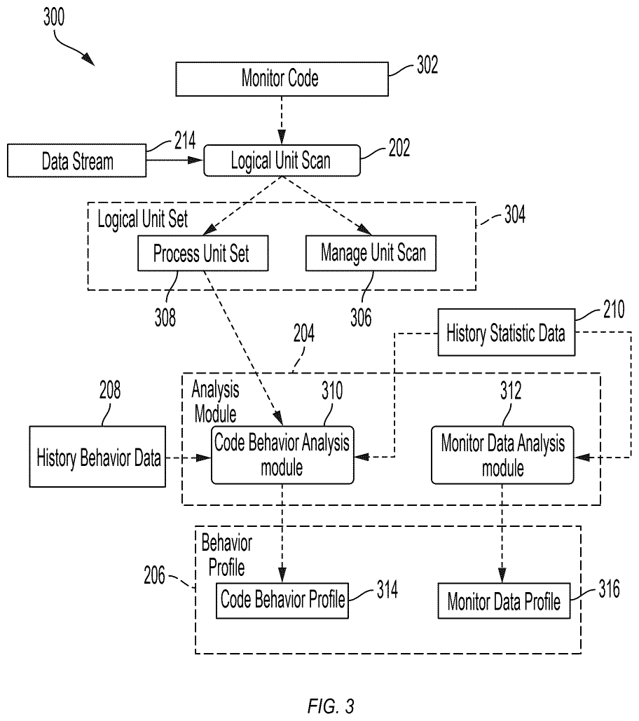

Referring now to FIG. 3, a block diagram illustrating a system 300 for performing anomaly detection-based self-health checks in monitoring products, according to one or more embodiments is shown. In exemplary embodiments, the system 300 for performing anomaly detection-based self-health checks in monitoring products integrates various modules and data flows to ensure comprehensive monitoring and analysis of program behavior and data characteristics.

In exemplary embodiments, the logical unit scan 202 scans the software code of an application that is being monitored, referred to herein as the monitored product, to identify and categorize different logical units. The logical unit scan 202 divides the code of the monitored product into manage units and process units. These units are responsible for controlling the process logics and processing data streams, respectively. The logical unit scan 202 ensures that all relevant logical units are identified and categorized for further analysis. In exemplary embodiments, the monitored code 302 represents the software code of the monitored product. The monitored code 302 includes various logical units that are scanned and analyzed by the logical unit scan 202. The monitored code 302 serves as the basis for building the behavior profile and detecting anomalies during runtime.
Select the stream used by a certain user by checking the input data streams: D_{#} d_{!}, . . . , d_{&}
d is a process unit that the data stream invoke.

In exemplary embodiments, the data stream 214 represents the flow of data through the monitor product, including raw data collected from various sources, which is then processed and analyzed by the system. The data stream 214 ensures that all relevant data is collected and fed into the monitoring system for further processing and analysis.

In exemplary embodiments, the logical unit set 304 is a collection of logical units identified by the logical unit scan 202. The logical unit set 304 includes both manage units and process units, which are responsible for controlling the process logics and processing data streams, respectively. The logical unit set 304 serves as the basis for building the behavior profile and detecting anomalies during runtime.

In exemplary embodiments, the manage unit set 306 is a subset of the logical unit set 304, specifically responsible for controlling the process logics of the monitored product. The mange unit set 306 is represented as M=m₁, . . . , m_{N}). The manage unit set 306 includes various functions of the monitored product that are identified and categorized by the logical unit scan 202. The manage unit set 306 ensures that all relevant manage units are included in the behavior profile and analyzed for anomalies. In exemplary embodiments, the logical unit set 304 scans the mange unit set 306 and divides the manage units into sets of process unit sets 308 by grouping manage units that are part of a single process into a process unit. Each process unit set 308 includes mange units that always execute together, i.e., that are part of a single process. The process unit sets 308 is represented as Pᵢ

In exemplary embodiments, the analysis module 204 processes the data collected from the logical unit scan 202, building a comprehensive behavior profile of the current system by analyzing history statistic data and history behavior data. The analysis module 204 formats the input data by data stream ID and performs code behavior analysis and monitor data analysis, calculating distribution scopes for each process unit and manage unit to detect anomalies during runtime. In exemplary embodiments, the history statistic data 210, collected during the typical monitor process, includes metadata about the data streams, such as data stream ID, packet ID, and packet size. The history statistic data 210 provides a historical record of the data processed by the monitor product, which is used to build the behavior profile and detect anomalies. The history behavior data 208 includes metadata about the process units, such as data stream ID, process unit, and the number of times the process unit has been called. The history behavior data 208 provides a historical record of the monitor product's behavior, which is used to build the behavior profile and detect anomalies. In one embodiment, the history statistic data 210 has a format of (SID, pid, psize), where SID is the data stream ID, used to specify the data stream, pid is the packet ID, used to specify a data packet form a data stream, and psize is the packet size.

In exemplary embodiments, the code behavior analysis module 310 performs analysis on the behavior of the code units identified by the logical unit scan 202. The code behavior analysis module 310 processes the historical behavior data and runtime behavior data to build a comprehensive behavior profile of the monitored product. The code behavior analysis module 310 ensures that any deviations from expected behavior are detected and analyzed.

In exemplary embodiments, the monitor data analysis module 312 performs analysis on the data processed by the monitor product. The monitor data analysis module 312 processes the historical statistic data and runtime statistic data to build a comprehensive data profile of the monitored product. The monitor data analysis module 312 ensures that any anomalies in the data are detected and analyzed. The behavior profile 206, generated by the analysis module 204, contains detailed information about the expected behavior of the monitor product, including distribution scopes for each process unit and manage unit, as well as expected packet sizes.

In exemplary embodiments, the behavior profile 206 is used as a reference during the self-health check process to detect any deviations from expected behavior. The code behavior profile 314 is a subset of the behavior profile 206, specifically focused on the behavior of the code units identified by the logical unit scan 202. The code behavior profile 314 includes distribution scopes for each process unit and manage unit, providing a detailed reference for detecting anomalies in the behavior of the monitored product. The monitor data profile 316 is another subset of the behavior profile 206, specifically focused on the data processed by the monitor product. The monitor data profile 316 includes distribution scopes for each data stream and expected packet sizes, providing a detailed reference for detecting anomalies in the data processed by the monitored product.

In exemplary embodiments, the analysis module 204 formats the data stream 214 by the SID. The code behavior analysis module 310 calculates an error for a process unit (Ep) associated with process unit corresponding the data in the data stream. The error for a process unit (Ep) is a function of the SID and psize. In exemplary embodiments, the code behavior analysis module 310 will calculate distribution scopes for each process unit invoked by the data stream, where the distribution scope is (pᵢ, uᵢ, lᵢ, . . . , pₖ, uₖ, lₖ) where p is a process unit, u is the upper limits for called times, l is the lower limits for called times. In exemplary embodiments, the monitor data analysis module 312 calculates an error for a manage unit (Em) associated with process unit corresponding the data in the data stream. The error for a manage unit (Em) is a function of the SID and psize. In exemplary embodiments, the monitor data analysis module 312 will calculate distribution scopes for each manage unit (SID, (mᵢ, uᵢ, lᵢ, . . . , mₖ, uₖ, lₖ)) and the expected packet size (SID, psizeᵤ*, psizeₗ), where m is a manage unit, u is the upper limits for called times, l is the lower limits for called times; psizeᵤ, and psizeₗ are the upper and lower limits for the packet size.

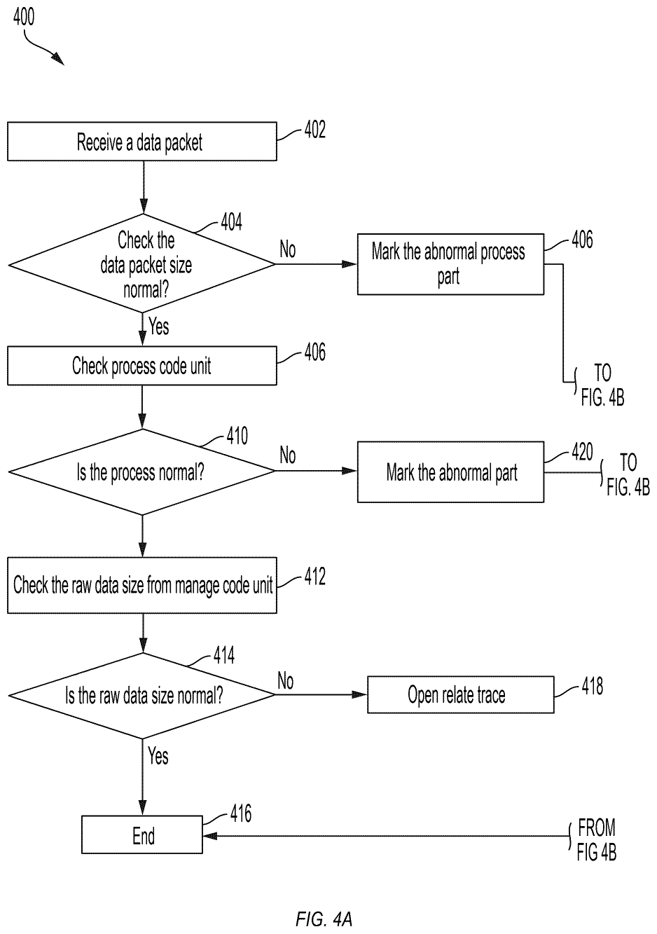

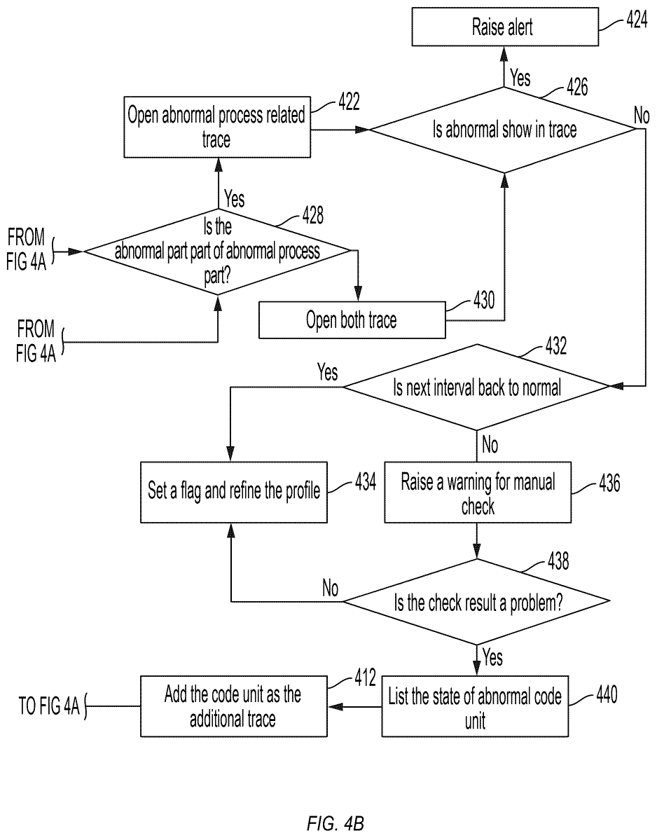

Referring now to FIGS. 4A and 4B, a flow chart illustrating a method 400 for performing a self-health check process for monitoring products based on anomaly detection, according to one or more embodiments is shown. The method 400 can be implemented by a system for anomaly detection-based self-health checks in monitoring products, such as the one shown in FIGS. 2 and 3.

The method 400 begins with receiving a data packet at step 402. This step initiates the process by obtaining the data packet that will be analyzed for anomalies. The data packet contains metadata such as data stream ID, packet ID, and packet size, which are used for tracking and analyzing the flow of data through the monitor product. For example, a data packet is received from a network monitoring tool, containing information about network traffic, including the size of the data packet and the source and destination IP addresses. Once the data packet is received, the data packet is sent to the Send the (SID, psize) to the monitor data profile to obtain the expected packet size (SID, psizeᵤ, psizeₗ) and the distribution scopes SID, (mᵢ, uᵢ, lᵢ, . . . , mₖ, uₖ, lₖ) and to the code behavior profile to obtain the distributions SID, (pᵢ, uᵢ, lᵢ, . . . , pₖ, uₖ, lₖ).

Next, as shown at step 404, the method 400 includes determining whether the data packet size is within the expected range, i.e., is psize∈(psizeₗ, psizeᵤ). This step involves comparing the packet size against predefined upper and lower limits specified in the behavior profile. If the data packet size is not within the expected range, the method proceeds to step 408 to mark the process part as abnormal. The abnormal process part refers to a specific segment or component of the overall process that is responsible for handling the data packet. This could include various units or modules within the monitoring system that process the data packet, such as code units, manage units, or process units. When the data packet size is not within the expected range, it indicates that there may be an issue with the part of the process that handled the data packet, and this part is marked as abnormal for further investigation. This helps in isolating and identifying the specific area within the process that may be causing the anomaly. If the data packet size is within the expected range, the method proceeds to step 406. For instance, the received data packet has a size of 1500 bytes, which is within the expected range of 1000 to 2000 bytes, so the process continues to the next step.

At step 406, the method 400 includes determining whether the process code unit associated with the data packet. This step involves analyzing the behavior of the process unit to determine if it is functioning correctly. The analysis includes checking the number of times the process unit has been called and comparing it against the expected distribution scopes. For example, the process code unit responsible for handling the data packet is analyzed and found to have been called 50 times in the last hour, which is within the expected range of 30 to 60 calls per hour. For manage units, determining whether the process is normal includes comparing if any unit mᵢ is out of the distribution range (mᵢ, uᵢ, lᵢ). For process units, determining whether the process is normal includes comparing if any process pᵢ is out of the distribution range (pᵢ, uᵢ, lᵢ).

At step 410, the method 400 determines if the process is functioning as expected. If the process is not standard, i.e., not within the expected range, the method proceeds to step 420 to mark the part as abnormal. The abnormal part refers to a specific segment or component of the overall process that is responsible for handling the data packet within the monitoring system. This could include various units or modules, such as code units, manage units, or process units, that are involved in processing the data packet. When the method determines that the process is not functioning as expected, it indicates that there may be an issue with the specific part of the process that handled the data packet. This part is then marked as abnormal for further investigation. Marking the process part as abnormal helps in isolating and identifying the specific area within the process that may be causing the anomaly, allowing for targeted debugging and resolution efforts. If the process is operating normally, the method 400 proceeds to step 412. For instance, the analysis shows that the process unit is functioning within the expected parameters, so the process continues to the next step.

At step 412, the method 400 includes checking the raw data size from the manage code unit associated with the data packet. This step involves verifying the size of the raw data processed by the manage code unit to ensure it falls within expected parameters. For example, the raw data size processed by the manage code unit is 1800 bytes, which is within the expected range of 1500 to 2000 bytes, so the process continues to the next step. At step 414, the method 400 determines if the raw data size is within expected parameters. If the raw data size is not within expected parameters, the method proceeds to step 418 to open the related trace. If the raw data size is within expected parameters, the method proceeds to step 416 to end the process. At step 416, the method 400 concludes the self-health check process. This step is reached when all checks have been completed, and no further anomalies are detected. For example, since all checks have passed, the self-health check process ends without any issues.

In exemplary embodiments, based on a determination that the raw data size is not within expected parameters, the method 400 opens the related trace at step 418. This step involves accessing the trace information related to the abnormal raw data size for further analysis. For example, the raw data size is found to be 2200 bytes, which is outside the expected range, so the related trace is opened to collect more information about the anomaly.

At step 428, the method 400 evaluates whether the identified abnormal part, marked at step 408, is part of the abnormal process part, marked at step 420. If the abnormal part is part of the abnormal process part, the method proceeds to step 422 and opens the abnormal process-related trace. If not, the method proceeds to step 430 and opens traces corresponding to both the abnormal process part and the abnormal part. At step 424, the method 400 raises an alert when an anomaly is detected. This step involves notifying the user or system of the detected anomaly. For example, an alert is raised to inform the system administrator about the abnormal raw data size and the related process unit.

At step 426, the method 400 determines if the collected trace information reveals any anomalies. If an anomaly is shown in the trace, the method proceeds to step 424 and a corrective action is performed. If no anomaly is shown in the trace, the method proceeds to step 432. For example, a monitoring system collects trace information about the performance of an application, including CPU usage, memory consumption, and response times. The expected behavior is that the trace data shows CPU usage and memory consumption remain within predefined limits, and response times are consistently low. However, during analysis, the trace reveals a significant increase in CPU usage and memory consumption, along with a sharp rise in response times. This deviation from the expected behavior indicates a potential anomaly, such as a memory leak or an inefficient algorithm. Since an anomaly is shown in the trace, the method proceeds to step 424 to raise an alert and perform corrective actions.

Corrective actions that may be taken include restarting the application, reallocating resources, or optimizing the code. For instance, if a memory leak is detected, the system may automatically restart the application to free up memory and prevent further degradation of performance. This action directly affects the operation of the application by resetting its state and clearing any accumulated memory issues. Another example is reallocating resources, such as increasing the CPU or memory allocation for the application. This can help the application handle higher loads and improve its performance. Additionally, optimizing the code by identifying and fixing inefficient algorithms can enhance the application's efficiency and reduce resource consumption.

These corrective actions can significantly improve the functioning of the processing system executing the application being monitored. Restarting the application can prevent crashes and ensure continuous availability. Reallocating resources can enhance the system's ability to handle peak loads and improve overall performance. Optimizing the code can lead to more efficient use of system resources, reducing CPU and memory usage, and improving response times. By addressing the root causes of anomalies, these actions help maintain the stability and reliability of the processing system, ensuring that it operates smoothly and efficiently.

At step 432, the method 400 determines if the system has returned to standard behavior in the next monitoring interval. If the next interval is back to standard, the method proceeds to step 434 to set a flag and refine the profile. If the next interval is not back to standard, the method proceeds to step 436. For example, the system behavior is monitored in the next interval, and it is found to be back to standard, so the process continues to the next step. At step 434, the method 400 sets a flag and refines the behavior profile based on the results of the self-health check process. This step involves updating the profile to incorporate the new information and improve future anomaly detection accuracy. For example, a flag is set to indicate that the behavior profile needs refinement, and the profile is updated with the new information.

At step 436, the method 400 raises a warning when the system remains abnormal after multiple self-health check intervals. This step involves notifying the user or system to perform a manual check on the detected anomaly. For example, a warning is raised to inform the system administrator that a manual check is required to investigate the persistent anomaly.

At step 438, the method 400 determines if the identified anomaly constitutes a significant problem based on the manual check. If the manual check result indicates a problem, the method proceeds to step 440 to list the state of the abnormal code unit. If not, the method proceeds to step 434. At step 440, the method 400 documents the state of the abnormal code unit identified during the self-health check process. This step involves recording the details of the anomaly, including the process unit, data stream, and nature of the deviation from expected behavior. For example, the state of the abnormal code unit is documented, including the details of the anomaly and the affected process unit. At step 442, the method 400 includes the identified abnormal code unit in the additional trace for future self-health checks. This step involves updating the behavior profile to include the new information and ensuring that the code unit is monitored closely in subsequent checks. For example, the abnormal code unit is added to the additional trace information, and the behavior profile is updated to improve future anomaly detection and debugging efforts.

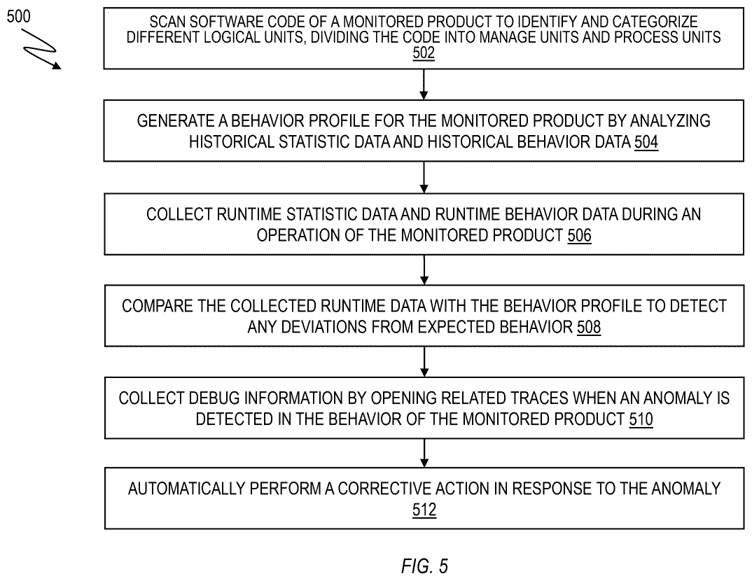

FIG. 5 is a flow chart illustrating for performing self-health checks in APM solutions through anomaly detection. As shown at block 502, the method 500 begins with scanning the software code of a monitored product to identify and categorize different logical units, dividing the code into manage units and process units. This scan ensures that all relevant logical units are identified and categorized for further analysis, which is used for building a comprehensive behavior profile and detecting anomalies during runtime.

Next, at block 504, a behavior profile for the monitored product is generated by analyzing historical statistic data and historical behavior data. The behavior profile includes distribution scopes for each process unit and manage unit, as well as expected packet sizes. Historical statistic data includes metadata about data streams, such as data stream ID, packet ID, and packet size, while historical behavior data includes metadata about process units, such as data stream ID, process unit, and the number of times the process unit has been called. This analysis provides a detailed reference for detecting anomalies in the behavior of the monitored product.

During the operation of the monitored product, runtime statistic data and runtime behavior data are collected, as shown at block. Runtime statistic data includes metadata about data streams and process units, while runtime behavior data includes metadata about process units and their behavior. This real-time data collection is necessary for detecting deviations from expected behavior and updating the behavior profile. The collected data is then compared with the behavior profile to detect any deviations from expected behavior (508). This comparison involves analyzing the runtime data against the distribution scopes and expected packet sizes defined in the behavior profile, identifying any anomalies.

When an anomaly is detected, debug information is dynamically collected by opening related traces, as shown at block 510. This step involves accessing trace information related to the detected anomaly for further analysis, helping to isolate and identify the specific area within the process that may be causing the anomaly. This targeted debugging approach facilitates efficient problem resolution and ensures that the monitoring system can provide timely alerts to the user.

In response to the detected anomaly, corrective actions are automatically performed, as shown at block 512. These actions may include restarting the monitored product, reallocating resources utilized by the monitored product, and optimizing the software code. For instance, restarting the application can prevent crashes and ensure continuous availability, while reallocating resources can enhance the system's ability to handle peak loads and improve overall performance. Optimizing the code can lead to more efficient use of system resources, reducing CPU and memory usage, and improving response times. These corrective actions directly affect the operation of the monitored product by addressing the root causes of anomalies, ensuring the stability and reliability of the monitored product.

In addition, the method 500 includes reporting detected anomalies to a user and updating the behavior profile based on user responses to the reported anomalies. This step ensures that the user is informed of any issues and can take appropriate action to resolve them. The behavior profile is updated based on the user's response, improving the accuracy of future anomaly detection and enhancing the overall effectiveness of the self-health check process.

In exemplary embodiments, the invention significantly improves the functioning of a computer by providing a robust method and system for performing self-health checks in monitoring products through anomaly detection in program behavior and data characteristics. By scanning the software code of a monitored product to identify and categorize different logical units, the invention can detect potential issues before they manifest as significant problems, allowing for proactive measures to be taken and preventing minor issues from escalating into major failures. The invention generates a behavior profile for the monitored product by analyzing historical statistic data and historical behavior data, which includes distribution scopes for each process unit and manage unit, as well as expected packet sizes. This detailed reference for expected behavior enables the system to more accurately identify deviations and potential anomalies.

During the operation of the monitored product, the invention collects runtime statistic data and runtime behavior data, ensuring that the system has up-to-date information on the performance and behavior of the monitored product. This real-time data collection allows for timely detection of any deviations from expected behavior. When an anomaly is detected, the invention dynamically collects debug information by opening related traces, helping to isolate and identify the specific area within the process that may be causing the anomaly. This targeted approach facilitates efficient problem resolution and reduces the time required for debugging.

The invention also automatically performs corrective actions in response to detected anomalies, such as restarting the monitored product, reallocating resources, and optimizing the software code. By addressing the root causes of anomalies, the system can prevent crashes, enhance the ability to handle peak loads, and improve overall performance. Additionally, the invention reports detected anomalies to a user and updates the behavior profile based on user responses, ensuring that the user is informed of any issues and can take appropriate action to resolve them. Updating the behavior profile based on user feedback improves the accuracy of future anomaly detection and enhances the overall effectiveness of the self-health check process.

By implementing these features, the invention ensures that the computer operates smoothly and efficiently. Early detection and proactive measures prevent downtime and reduce the risk of data loss. Real-time monitoring and dynamic debugging facilitate quick resolution of issues, minimizing the impact on system performance. Automated corrective actions optimize resource utilization and improve the system's ability to handle varying workloads. Overall, the invention enhances the stability, reliability, and performance of the computer, ensuring that it functions at an optimal level.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method for performing self-health checks in monitoring products, the method comprising:
scanning software code of a monitored product to identify and categorize different logical units, dividing the code into manage units and process units;
generating a behavior profile for the monitored product by analyzing historical statistic data and historical behavior data, the behavior profile including distribution scopes for each process unit and manage unit and expected packet sizes for each process unit and manage unit;
collecting runtime statistic data and runtime behavior data during an operation of the monitored product;
comparing the collected runtime data with the behavior profile to detect any deviations from expected behavior;
collecting debug information by opening related traces when an anomaly is detected in the behavior of the monitored product; and
automatically performing a corrective action in response to the anomaly.

2. The computer-implemented method of claim 1, further comprising reporting detected anomalies to a user and updating the behavior profile based on user responses to the reported detected anomalies.

3. The computer-implemented method of claim 1, wherein the historical statistic data includes metadata about data streams, such as data stream ID, packet ID, and packet size.

4. The computer-implemented method of claim 1, wherein the historical behavior data includes metadata about process units, such as data stream ID, process unit, and a number of times the process unit has been called.

5. The computer-implemented method of claim 1, wherein the runtime statistic data includes metadata about data streams and process units.

6. The computer-implemented method of claim 1, wherein the runtime behavior data includes metadata about process units and their behavior.

7. The computer-implemented method of claim 1, wherein the corrective action includes one or more of restarting the monitored product, reallocating resources utilized by the monitored product, and optimizing the software code.

8. A system comprising:
a memory comprising computer readable instructions; and
a processing device for executing the computer readable instructions, the computer readable instructions controlling the processing device to perform operations comprising:
scanning software code of a monitored product to identify and categorize different logical units, dividing the code into manage units and process units;
generating a behavior profile for the monitored product by analyzing historical statistic data and historical behavior data, the behavior profile including distribution scopes for each process unit and manage unit and expected packet sizes for each process unit and manage unit;
collecting runtime statistic data and runtime behavior data during an operation of the monitored product;
comparing the collected runtime data with the behavior profile to detect any deviations from expected behavior;
collecting debug information by opening related traces when an anomaly is detected in the behavior of the monitored product; and
automatically performing a corrective action in response to the anomaly.

9. The system of claim 8, wherein the operations further comprise reporting detected anomalies to a user and updating the behavior profile based on user responses to the reported detected anomalies.

10. The system of claim 8, wherein the historical statistic data includes metadata about data streams, such as data stream ID, packet ID, and packet size.

11. The system of claim 8, wherein the historical behavior data includes metadata about process units, such as data stream ID, process unit, and a number of times the process unit has been called.

12. The system of claim 8, wherein the runtime statistic data includes metadata about data streams and process units.

13. The system of claim 8, wherein the runtime behavior data includes metadata about process units and their behavior.

14. The system of claim 8, wherein the corrective action includes one or more of restarting the monitored product, reallocating resources utilized by the monitored product, and optimizing the software code.

15. A computer program product for performing self-health checks in monitoring products, the computer program product comprising:
a set of one or more computer-readable storage media;
program instructions, collectively stored in the set of one or more storage media, for causing a processor set to perform the following computer operations:
scanning software code of a monitored product to identify and categorize different logical units, dividing the code into manage units and process units;
generating a behavior profile for the monitored product by analyzing historical statistic data and historical behavior data, the behavior profile including distribution scopes for each process unit and manage unit and expected packet sizes for each process unit and manage unit;
collecting runtime statistic data and runtime behavior data during an operation of the monitored product;
comparing the collected runtime data with the behavior profile to detect any deviations from expected behavior;
collecting debug information by opening related traces when an anomaly is detected in the behavior of the monitored product; and
automatically performing a corrective action in response to the anomaly.

16. The computer program product of claim 15, wherein the operations further comprise reporting detected anomalies to a user and updating the behavior profile based on user responses to the reported detected anomalies.

17. The computer program product of claim 15, wherein the historical statistic data includes metadata about data streams, such as data stream ID, packet ID, and packet size.

18. The computer program product of claim 15, wherein the historical behavior data includes metadata about process units, such as data stream ID, process unit, and a number of times the process unit has been called.

19. The computer program product of claim 15, wherein the runtime statistic data includes metadata about data streams and process units.

20. The computer program product of claim 15, wherein the runtime behavior data includes metadata about process units and their behavior.
